(19) United States
(12) Patent Application Publication
(10) Pub. No.: US 2023/0224630 A1
(43) Pub. Date: Jul. 13, 2023

(54) VIBRATION SENSOR

(71) Applicant: SHENZHEN SHOKZ CO., LTD., Shenzhen (CN)

(72) Inventors: Jinbo ZHENG, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 18/185,352

(22) Filed: Mar. 16, 2023

Related U.S. Application Data
(63) Continuation of application No. PCT/CN2020/140180, filed on Dec. 28, 2020.

(51) Int. Cl. H04R 1/28; H04R 1/04; H04R 1/08

(52) U.S. Cl. CPC H04R 1/2807; H04R 1/04; H04R 1/08; H04R 3/00

(57) ABSTRACT

A vibration sensor (100) is provided, including a housing structure (110, 510, 610, 710, 810, 910, 1010, 1110, 1510, 1710) and an acoustic transducer (120, 520, 620, 720, 820, 920, 1020, 1120, 1220, 1320, 1420, 1520, 1720) physically connected to the housing structure (110, 510, 610, 710, 810, 910, 1010, 1110, 1510, 1710), wherein a first acoustic cavity (140, 1040) is formed at least partially by the housing structure (110, 510, 610, 710, 810, 910, 1010, 1110, 1510, 1710) and the acoustic transducer (120, 520, 620, 720, 820, 920, 1020, 1120, 1220, 1320, 1420, 1520, 1720), and a vibration unit (130) which is located in the first acoustic cavity (140, 1040), and separates the first acoustic cavity (140, 1040) into a second acoustic cavity (142, 542, 642, 742, 842, 942, 1042, 1142, 1242, 1342, 1442, 1542, 1642) and a third acoustic cavity (141, 941, 1041, 1141, 1541, 1641).

### CROSS-REFERENCE TO RELATED APPLICATIONS

This application is a Continuation of International Patent Application No. PCT/CN2020/140180, filed on Dec. 28, 2020, the contents of which are hereby incorporated by reference to its entirety.

### TECHNICAL FIELD

The present disclosure relates to the field of acoustics, and in particular to a vibration sensor.

### BACKGROUND

A vibration sensor is an energy conversion device that converts vibration signals into electrical signals. At present, the vibration sensor may be used as a bone conduction microphone. The vibration sensor can detect a vibration signal transmitted through the skin when a person speaks, so as to detect the voice signal without being disturbed by external noise. A common problem of the current vibration sensor may be that the vibration signal of the human body is relatively small, the vibration sensor cannot receive a good vibration signal, and voice quality obviously drops.

Therefore, it is desirable to provide a vibration sensor with a higher sensitivity to meet performance requirements of the bone conduction microphone while the vibration sensor has a specific resonant frequency.

### SUMMARY

Embodiments of the present disclosure provide a vibration sensor, the vibration sensor includes a housing structure and an acoustic transducer, wherein the acoustic transducer is physically connected to the housing structure, a first acoustic cavity is formed at least partially by the housing structure and the acoustic transducer. The vibration sensor further includes a vibration unit, wherein the vibration unit is located in the first acoustic cavity, and separates the first acoustic cavity into a second acoustic cavity and a third acoustic cavity, the second acoustic cavity is in acoustic communication with the acoustic transducer. The housing structure may be configured to vibrate based on an external vibration signal, the vibration unit may change a volume of the second acoustic cavity in response to the vibration of the housing structure, and the acoustic transducer may generate an electrical signal based on the volume change of the second acoustic cavity. The vibration unit may act on the second acoustic cavity so that a resonance frequency of the vibration sensor is 800 Hz-8000 Hz.

In some embodiments, the vibration unit, the housing structure and the acoustic transducer may form a resonant system, and a quality factor of the resonant system may be 0.7-10.

In some embodiments, the vibration unit may include a mass element and an elastic element, and the mass element may be connected to the housing structure or the acoustic transducer through the elastic element.

In some embodiments, the elastic strength of the elastic element may be 10 N/m-2000 N/m.

In some embodiments, a mass of the mass element is 0.001 g-1 g.

In some embodiments, the elastic element is located on a side of the mass element away from the acoustic transducer, one end of the elastic element is connected to the housing structure, and the other end of the elastic element is connected to the mass element.

In some embodiments, a first protrusion is disposed on the side of the mass element away from the acoustic transducer.

In some embodiments, the vibration sensor may further include a circuit board configured to receive and transmit the electrical signal output by the acoustic transducer; wherein the circuit board is located on a side of the acoustic transducer opposite to the mass element.

In some embodiments, the elastic element is located on a side of the mass element facing the acoustic transducer, one end of the elastic element is connected to the mass element, and the other end of the elastic element is connected to the acoustic transducer.

In some embodiments, the side of the mass element facing the acoustic transducer is provided with a second protrusion.

In some embodiments, the side of the mass element facing the acoustic transducer is provided with a third protrusion, and the third protrusion at least partially protrudes into the acoustic transducer, and is opposite to a position of a diaphragm of the acoustic transducer.

In some embodiments, the elastic element is a planar structure, the elastic element is located on the side of the mass element facing the acoustic transducer, the elastic element is connected to the housing structure, and a side surface of the mass element facing the acoustic transducer is connected with the elastic element.

In some embodiments, the elastic element is located on a peripheral side of the mass element, an outer side of the elastic element is connected to the housing structure, and an inner side of the elastic element is connected to the mass element.

In some embodiments, the elastic element is located on a peripheral side of the mass element, an inner side of the elastic element is connected to the mass element, and an end of the elastic element is connected to the housing structure or the acoustic transducer.

In some embodiments, a cross-sectional shape of the elastic element is a rectangle, a trapezoid, a parallelogram, an arc, or a wave.

In some embodiments, at least one first pressure relief hole is provided on the mass element, and the at least one first pressure relief hole penetrates through the mass element.

In some embodiments, the elastic element is provided with at least one second pressure relief hole, and the at least one second pressure relief hole passes through the elastic element.

In some embodiments, a cross-sectional area of the mass element is larger than a cross-sectional area of the acoustic transducer.

In some embodiments, a gap distance between the elastic element and the housing structure and a gap distance between the elastic element and the acoustic transducer are less than or equal to 0.1 mm .

### BRIEF DESCRIPTION OF THE DRAWINGS

The present disclosure will be further described in the form of exemplary embodiments, which will be described in detail by the accompanying drawings. These embodiments are not restrictive. In these embodiments, the same number represents the same structure, wherein:

FIG. 1 is a schematic structural diagram of a vibration sensor according to some embodiments of the present disclosure;

FIG. 2 is a frequency response curve diagram of a vibration sensor according to some embodiments of the present disclosure;

FIG. 3 is a frequency response curve diagram of a vibration sensor according to some embodiments of the present disclosure;

FIG. 4 is a frequency response curve diagram of a vibration sensor according to some embodiments of the present disclosure;

FIG. 5 is a schematic structural diagram of a vibration sensor according to some embodiments of the present disclosure;

FIG. 6 is a schematic structural diagram of a vibration sensor according to some embodiments of the present disclosure;

FIG. 7 is a schematic structural diagram of a vibration sensor according to some embodiments of the present disclosure;

FIG. 8 is a schematic structural diagram of a vibration sensor according to some embodiments of the present disclosure;

FIG. 9 is a schematic structural diagram of a vibration sensor according to some embodiments of the present disclosure;

FIG. 10 is a schematic structural diagram of a vibration sensor according to some embodiments of the present disclosure;

FIG. 11 is a schematic structural diagram of a vibration sensor according to some embodiments of the present disclosure;

FIG. 12 is a schematic structural diagram of a vibration sensor according to some embodiments of the present disclosure;

FIG. 13 is a schematic structural diagram of a vibration sensor according to some embodiments of the present disclosure;

FIG. 14 is a schematic structural diagram of a vibration sensor according to some embodiments of the present disclosure;

FIG. 15 is a schematic structural diagram of a vibration sensor according to some embodiments of the present disclosure;

FIG. 16 is a schematic structural diagram of a vibration sensor according to some embodiments of the present disclosure; and

FIG. 17 is a schematic structural diagram of a vibration sensor according to some embodiments of the present disclosure.

### DETAILED DESCRIPTION

In order to more clearly explain the technical scheme of the embodiments of the present disclosure, the following will briefly introduce the drawings that need to be used in the description of the embodiments. Obviously, the drawings in the following description are only some examples or embodiments of the present disclosure. For those skilled in the art, the present disclosure can also be applied to other similar scenarios according to these drawings without creative work. Unless it is obvious from the language environment or otherwise stated, the same label in the figure represents the same structure or operation.

It should be understood that the “system”, “device”, “unit” and/or “module” used herein is a method for distinguishing different components, elements, portions or assemblies at different levels. However, if other words can achieve the same purpose, they can be replaced by other expressions.

As shown in the present disclosure, unless the context expressly indicates exceptions, the words “a”, “an”, “the”, “one”, and/or “this” do not specifically refer to the singular form, but may also include the plural form as well; and the plural form may be intended to include the singular form as well, unless the context clearly indicates otherwise. Generally speaking, the terms “include”, “including”, “includes”, “comprise”, “comprising”, and/or “comprises” only indicate that the steps and/or elements that have been clearly identified are included, and these steps and/or elements do not constitute an exclusive list. Methods or devices may also include other steps or elements.

A flowchart is used in this disclosure to explain the operations performed by the system according to the embodiments of the present disclosure. It should be understood that the previous or subsequent operations are not necessarily performed accurately in order. Instead, the operations may be processed in a reverse order or simultaneously. At the same time, you can add other operations may be added to these processes, or one or more operations may be removed from these processes.

The present disclosure describes a vibration sensor. The vibration sensor may be used as a bone conduction microphone, which can receive vibration signals of human tissues such as bones and skin generated when people speak, and convert the vibration signals into electrical signals containing sound information. The vibration sensor may hardly collect sound in the air, so the vibration sensor may be suitable for collecting a voice signal when the user speaks in a noisy environment. In some embodiments, the noisy environment may include a noisy restaurant, a meeting place, a street, a near road, a fire scene, etc. The vibration sensor may be protected to a certain extent from an influence of voice of others around, noise generated by vehicles passing by and various other environmental noises. In some embodiments, the vibration sensor may include a housing structure and a vibration unit. A first acoustic cavity may be least partially limited to form. The vibration unit may be located in the first acoustic cavity and separate the first acoustic cavity into a second acoustic cavity and a third acoustic cavity. The second acoustic cavity may be acoustically connected with an acoustic transducer. Further, the housing structure may be configured to generate vibration based on external vibration signals (for example, signals generated by vibration of bones, skin, etc. when a user speaks). The vibration unit may change a volume of the second acoustic cavity in response to the vibration of the housing structure. The acoustic transducer may generate electrical signals based on a change of the volume of the second acoustic cavity. In some embodiments, a resonant frequency of the vibration sensor may be 800 Hz~8000 Hz by adjusting parameters of a mass unit and/or an elastic unit in the vibration unit, a position relative to other components, and a connection mode, thereby improving a sensitivity of the vibration sensor in a specific frequency band (for example, less than 8000 Hz). It should be noted that the parameters may refer to a shape, size, material, etc. of the mass element and/or elastic element. In addition, the specific frequency band may be not limited to the above example of less than 8000 Hz, but also may be less than 6000 Hz, less than 4500 Hz, less than 3000 Hz, less than 2500 Hz, less than 2000 Hz, etc., which may not be further defined here.

In some embodiments, the vibration sensor may be applied to an earphone (such as an air conduction earphone and a bone conduction earphone), a hearing aid, glasses, a helmet, an augmented reality (AR) device, a virtual reality (VR) device, or the like.

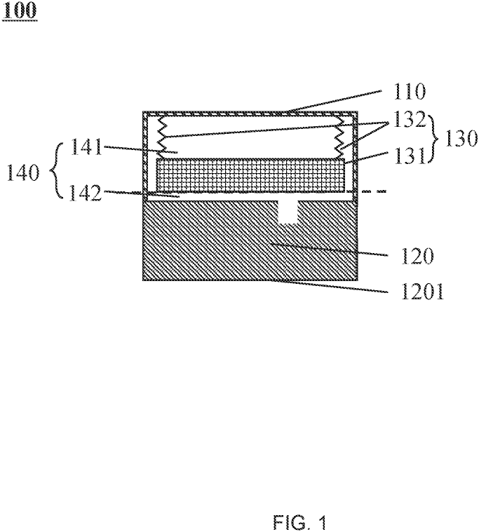

FIG. 1 is a schematic structural diagram of a vibration sensor according to some embodiments of the present disclosure. As shown in FIG. 1, the vibration sensor 100 may include a housing structure 110, an acoustic transducer 120, and a vibration unit 130. A shape of the vibration sensor 100 may be a cuboid, a cylinder or other regular or irregular structure. In some embodiments, the housing structure 110 and the acoustic transducer 120 may be physically connected, and the physical connection here may include welding, clamping, bonding, or integrated molding. In some embodiments, the housing structure 110 and the acoustic transducer 120 may form a package structure with a first acoustic chamber 140, wherein the vibration unit 130 may be located in the first acoustic chamber 140 of the package structure. In some embodiments, the housing structure 110 may independently form a package structure with a first acoustic cavity 140, wherein the vibration unit 130 and the acoustic transducer 120 may be located in the first acoustic cavity 140 of the package structure. In some embodiments, the vibration unit 130 may separate the first acoustic chamber 140 into the second acoustic chamber 142 and the third acoustic chamber 141. The second acoustic cavity 142 may be acoustically connected with the acoustic transducer 120. In some embodiments, the third acoustic cavity 141 may be an acoustic sealed cavity structure.

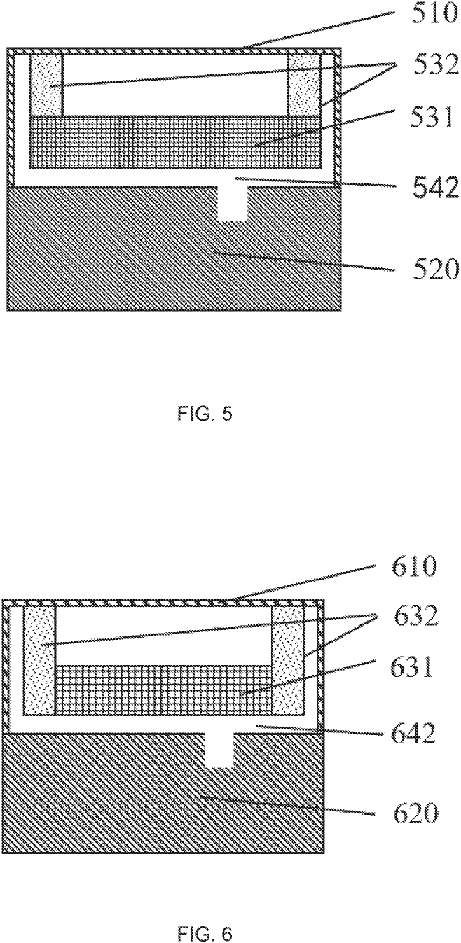

In some embodiments, the vibration unit 130 may include a mass element 131 and an elastic element 132. In some embodiments, the mass element 131 may be connected with the housing structure 110 through the elastic element 132. For example, the elastic element 132 may be located on a side of the mass element 131 away from the acoustic transducer 120, one end of the elastic element 132 may be connected with the housing structure 110, and another end of the elastic element 132 may be connected with the mass element 131. In other embodiments, the elastic element 132 may also be located on a peripheral side of the mass element 131, wherein an inner side of the elastic element 132 may be connected with the peripheral side of the mass element 131, and an outer side of the elastic element 132 or a side away from the acoustic transducer 120 may be connected with the housing structure 110. The peripheral side of the mass element 131 here may be relative to a vibration direction of the mass element 131. For convenience, it may be considered that the vibration direction of the mass element 131 relative to the housing structure 110 may be an axial direction. At this time, the peripheral side of the mass element 131 may represent a side of the mass element 131 that is set around the axis. In some embodiments, the mass element 131 may also be connected with the acoustic transducer 120 through the elastic element 132. The exemplary elastic element 132 may be in a form of a circular tube, a square tube, a special-shaped tube, a ring, a flat plate, or the like. In some embodiments, the elastic element 132 may have a structure (for example, a spring structure, a metal ring, etc.) that may be easy to undergo elastic deformation, and a material of the elastic element 132 may be a material that may be easy to undergo elastic deformation, such as silica gel, rubber, etc. In the embodiments of the present disclosure, the elastic element 132 may be more likely to undergo elastic deformation than the housing structure 110, so that the vibration element 130 may move relative to the housing structure 110. It should be noted that in some embodiments, the mass element 131 and the elastic element 132 may be composed of same or different materials, and then form the vibration unit 130 by assembling the mass element 131 and the elastic element 132 together. In some embodiments, the mass element 131 and the elastic element 132 may also be composed of the same material, and then formed into the vibration unit 130 through integrated molding. The specific description of the mass element 131 may refer to content elsewhere in the specification of the present disclosure (for example, FIG. 5 and related content).

The vibration sensor 100 may convert an external vibration signal into an electrical signal. In some embodiments, the external vibration signal may include a vibration signal when a person speaks, a vibration signal generated by the skin moving with the human body or working with a loudspeaker close to the skin, and a vibration signal generated by an object or air in contact with the vibration sensor, or the like, or any combination thereof. Further, the electrical signal generated by the vibration sensor may be input to an external electronic device. In some embodiments, the external electronic device may include a mobile device, a wearable device, a virtual reality device, an augmented reality device, or the like, or any combination thereof. In some embodiments, the mobile device may include a smartphone, a tablet, a personal digital assistant (PDA), a game device, a navigation device, or the like, or any combination thereof. In some embodiments, the wearable device may include a smart bracelet, a headphone, a hearing aid, a smart helmet, a smart watch, smart clothes, a smart backpack, a smart accessory, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include Google®™ Glass, Oculus Rift™, Hololens, Gear™ VR, etc. When the vibration sensor works, the external vibration signal may be transmitted to the vibration unit 130 through the housing structure 110, and the vibration unit 130 may vibrate in response to vibration of the housing structure 110. Since a vibration phase of the vibration unit 130 may be different from vibration phases of the housing structure 110 and the acoustic transducer 120, vibration of the vibration unit 130 may cause a volume change of the second acoustic cavity 142, thereby causing a sound pressure change of the second acoustic cavity 142. The acoustic transducer 120 may detect a change of a sound pressure of the second acoustic cavity 142, convert the change of the sound pressure into an electrical signal, and transmit the electrical signal to the external electronic device through a solder joint 1201. The solder joint 1201 here may be electrically connected with an internal component (for example, a processor) of a device such as an earphone, a hearing aid, augmented reality glasses, an augmented reality helmet, virtual reality glasses, etc. through data lines, and electrical signals acquired by the internal components may be transmitted to the external electronic device through wired or wireless means. In some embodiments, the acoustic transducer 120 may include a diaphragm (not shown in FIG. 1). When the sound pressure of the second acoustic cavity 142 changes, air inside the second acoustic cavity 142 may vibrate and act on the diaphragm, causing deformation of the diaphragm. The acoustic transducer 120 may convert a vibration signal of the diaphragm into an electrical signal.

Just as an example, suppose that the external vibration signal transmitted to the vibration sensor may be a periodic vibration, and a vibration frequency of the external vibration signal may be ƒ. At this time, the vibration of the housing structure 110 may be expressed as:

$${l}_{1} \left(ω\right) = A \left(ω\right) cos \left(ω t\right) ,$$

wherein, ω = 2πƒ is an angular frequency, l₁(ω) is a displacement of the housing structure 110 at the angular frequency ω, and A(ω) is a maximum displacement of the housing structure 110 at the angular frequency ω. The vibration of the housing structure 110 may be transmitted to the mass element 131 through the elastic element 132, and the displacement of the mass element 131 may be generate vibration. The vibration of the mass element 131 may be expressed as:

$${l}_{2} \left(ω\right) = \frac{\left(k - j c ω\right)}{\left(- m {ω}^{2} - j c w + k\right)} A \left(ω\right) cos \left(ω t\right) ,$$

wherein, l₂(ω) is a displacement of the mass element 131, m is a mass of the mass element 131; k is an elastic strength of the elastic element 132, and c is a damping of a resonance system formed by the vibration unit 130, the housing structure 110, and the acoustic transducer 120; and the damping c of the resonance system mainly comes from the elastic element 132. Considering that the vibration phases of the acoustic transducer 120 and the housing structure 110 may be the same or approximately the same, a vibration phase of the mass element 131 may be different from a common vibration phase of the housing structure 110 and the acoustic transducer 120, causing a volume of the second acoustic cavity 142 to change, and further causing the sound pressure of the second acoustic cavity 142 to change. A corresponding volume change of the second acoustic cavity 142 may be expressed as:

$$Δ V = \left({l}_{1} \left(ω\right) - {l}_{2} \left(ω\right)\right) S = \frac{m {ω}^{2}}{\left(m {ω}^{2} + j c ω - k\right)} S A \left(ω\right) c o s \left(ω t\right) ,$$

wherein, S is a cross-sectional area of the mass element 131 perpendicular to the axial direction. A sound pressure change of the second acoustic cavity 142 may be expressed as:

$$Δ p = \frac{Δ V}{V} ,$$

wherein, V is the volume of the second acoustic cavity 142 in a natural state. The acoustic transducer 120 may convert a change of the sound pressure into a change of a voltage or current, which may be transmitted through the solder joint 1201. It should be noted that the natural state here may refer to a state when the vibration sensor is not working, that is, a non-working state.

According to the above formulas (1), (2) and (3), when accelerations of the external periodic vibration at each frequency are the same, that is

$$A \left(ω\right) = \frac{{A}_{0}}{{ω}^{2}} ,$$

a relationship between the sound pressure change of the second acoustic cavity 142 and the angular frequency is expressed as:

$$Δ p = \frac{S {A}_{0}}{V} \frac{1}{\left({ω}^{2} + j ω \frac{c}{m} - \frac{k}{m}\right)} c o s \left(ω t\right) ,$$

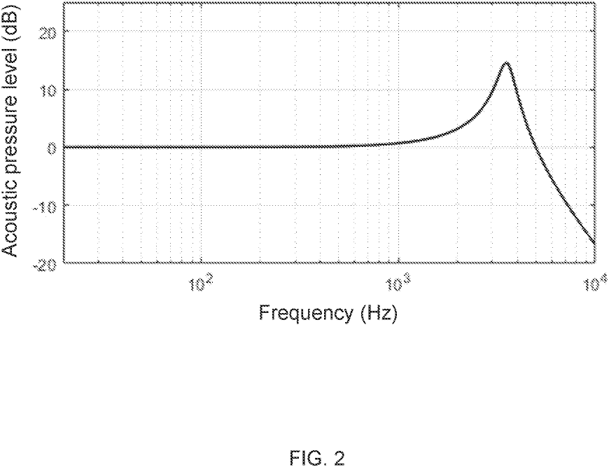

FIG. 2 is a frequency response curve of a vibration sensor according to some embodiments of the present disclosure. As shown in FIG. 2, the vibration unit 130 acting on the second acoustic cavity 142 may make a resonant frequency of the vibration sensor within a range of 3000 Hz to 4000 Hz. Since a response of the vibration sensor to the external vibration signal is related to a change of the sound pressure of the second acoustic cavity 142, it can be seen from Formula (5) that the resonant frequency of the vibration sensor may depend at least in part on the mass m of the mass element 131, the elastic strength k of the elastic element 132, and the damping c mainly derived from the elastic element 132 in the resonant system. Therefore, in some embodiments, when parameters of the vibration unit 130 (such as the mass of the mass element and the elastic strength of the elastic element) meet certain conditions, the vibration unit 130 acting on the second acoustic cavity 142 may make the resonant frequency of the vibration sensor be 800 Hz to 20000 Hz. According to preference for example, the vibration unit 130 acting on the second acoustic cavity 142 may make the resonant frequency of the vibration sensor be 900 Hz to 10000 Hz, 1000 Hz to 8000 Hz, 1150 Hz~5500 Hz, 1500 Hz to 3000 Hz, or 2000 Hz to 2800 Hz. In some embodiments, by adjusting a resonant frequency range of the vibration sensor, in some cases, the sensitivity of the vibration sensor can be improved without affecting the performance of the vibration sensor to actually receive effective vibration signals. For example, in some embodiments, by adjusting the resonant frequency of the vibration sensor to about 2000 Hz, the vibration sensor may have a performance of recording music. As another example, in some embodiments, by adjusting the resonant frequency of the vibration sensor to about 1000 Hz, a frequency response curve of the vibration sensor below 800 Hz may be relatively flat, and a performance of voice recording may be better.

For a more clear description, the resonance frequency of the vibration sensor may be expressed as:

$${ω}_{0} = \sqrt{\frac{k}{m}}$$

From the formulas (5) and (6) that when

$$\frac{k}{m}$$

is decreased, a sound pressure change Δp of the second acoustic cavity 142 may become larger, and at the same time, the resonant frequency of the vibration sensor may decrease.

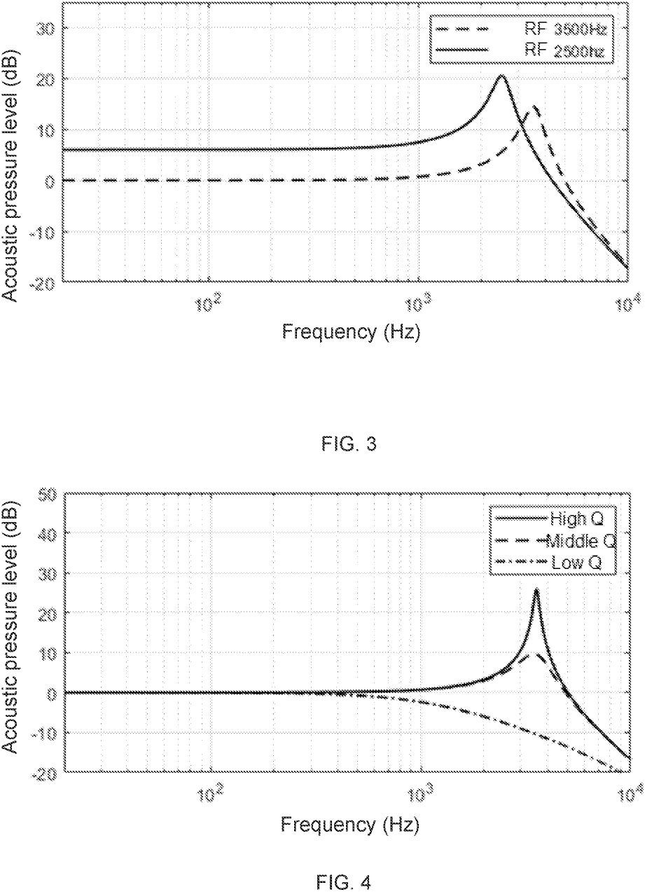

FIG. 3 is a frequency response curve of a vibration sensor according to some embodiments of the present disclosure. In some embodiments, the sensitivity of the vibration sensor may be improved within a specific frequency range by reducing the resonant frequency. The specific frequency range here may refer to 20 Hz~3000 Hz. In other embodiments, the specific frequency range may be adjusted according to an actual situation, and no further limitation may be made here. As an example, as shown in FIG. 3, when the resonant frequency of the vibration sensor decreases from 3500 Hz to 2500 Hz, a sensitivity of the vibration sensor may increase by about 6 dB in a range of frequency of less than 1000 Hz. Furthermore, when the frequency is about 2500 Hz, the sensitivity of the vibration sensor may increase by about 12 dB. In some embodiments, by adjusting the elastic strength k of the elastic element 132 and the mass m of the mass element 131, the resonant frequency of the vibration sensor may be in an appropriate frequency range, so that the sensitivity of the vibration sensor can be significantly improved within a certain frequency range, and the performance of the vibration sensor when receiving external vibration signals may not be affected.

Taking the vibration sensor with a cylindrical housing structure, a cylindrical elastic element and a cylindrical mass element as an example, the first acoustic cavity may be cylindrical (or nearly cylindrical), and the elastic strength of the elastic element may be expressed as:

$$k = \frac{{E}_{1} {S}_{1}}{{h}_{1}} ,$$

wherein, E₁ is an elastic modulus of the elastic element, S₁ is an axial cross-sectional area of the elastic element, h₁ is an axial height of the elastic element (that is, a dimension of the elastic element along the axial direction). The mass of a mass element may be expressed as:

$$m = {S}_{2} {h}_{2} ρ ,$$

wherein S₂ is an axial cross-sectional area of the mass element, h₂ is the axial height of the mass element, and p is a density of the mass element. From the formulas (7) and (8), the formula (9) may be deduced:

$${ω}_{0} = \sqrt{\frac{k}{m}} = \sqrt{\frac{{E}_{1} {S}_{1}}{{S}_{2}} \frac{1}{{h}_{1} {h}_{2}}}$$

It may be seen from formula (9) that the resonant frequency ω₀ may be maintained unchanged, i.e., when h₁h₂ is a certain value, when h₁ = h₂, an axial height h = h₁ + h₂ of the vibration unit may be minimum. Thus, by adjusting an axial height h₁ of the elastic element and an axial height h₂ of the mass element, the axial heights of the two may be close to each other, so that a volume of the vibration sensor may be small and the resonant frequency of the vibration sensor may be not affected. According to preference for example, a difference between the axial height of the elastic element and the axial height of the mass element may be less than 70%, 50%, 20%, or 5% of the axial height of the vibration unit.

In some embodiments, by adjusting the shape, volume, or structure of the mass element (for example, using a special-shaped mass element), the resonant frequency of the vibration sensor may be changed without increasing the axial height of the vibration unit and the volume of the vibration sensor. In some embodiments, the resonant frequency of the vibration sensor may also be reduced by reducing the axial cross-sectional area of the mass element. According to preference for example, a ratio of the axial cross-sectional area S₁ of the elastic element with the axial cross-sectional area S₂ of the mass element may be between 1:2 ~ 1:10, 1:2 ~ 1:5, or 1:2 ~ 1:4.

It should be noted that the above description of adjusting the resonant frequency of the vibration sensor or the volume of the mass unit is only an example and should not be considered as an only feasible implementation. Obviously, for professionals in the field, after understanding a basic principle of the above adjustment manner, they may make various corrections and changes in form and detail to a specific manner and steps of implementing the vibration sensor without departing from this principle, but these corrections and changes are still within the scope described above. For example, the vibration sensor may be of a regular or irregular shape, such as a cuboid or a frustum. As another example, the elastic element may be in a shape of a square tube, a special-shaped tube, a ring, a flat plate, etc. As another example, the mass element may be in a shape of a box, a trapezoid, a cone, a pyramid, or an irregular shape, etc. Professionals in the art may apply basic principles of the above adjustment manner to vibration sensors with different shapes or different shapes of internal components.

In some embodiments, the elastic strength k of the elastic element 132 may be between 10 N/m ~ 2000 N/m. According to preference for example, the elastic strength k of the elastic element 132 may be between 100 N/m and 1000 N/m, or 400 N/m and 700 N/m. The value of the mass m of the mass element 131 may be between 0.001 g ~ 1 g. According to preference for example, the value of the mass m of the mass element 131 may be between 0.005 g ~ 0.5 g or 0.01 g ~ 0.05 g.

In some embodiments, factors affecting the resonant frequency and sensitivity in the resonant system may be integrated, and a quality factor of the resonant system may be considered. An expression of the quality factor of the resonant system is:

$$Q = \frac{\sqrt{m k}}{c}$$

FIG. 4 is a frequency response curve of a vibration sensor according to some embodiments of the present disclosure. As shown in FIG. 4, when a quality factor Q of the resonant system is high, a sensitivity of a high frequency band (for example, 800 Hz ~ 8000 Hz) of the vibration sensor may change greatly, which may be not convenient for the vibration sensor to process the vibration signal of the band. When the quality factor Q of the resonant system is low, the sensitivity of the vibration sensor may decrease rapidly in a middle and high frequency band, making the sensitivity of the vibration sensor low in the middle and high frequency band. Therefore, by adjusting the damping c of the resonant system, the mass m of the mass element 131, and the elastic strength k of the elastic element 132, a value of the quality factor Q of the resonant system may be kept within a certain range, so that the vibration sensor may have a high sensitivity in the middle and high frequency bands, and a change of the sensitivity may be relatively stable. For example, a value of the quality factor Q of the resonant system may be between 0.7-10. According to preference for example, the value of the quality factor Q of the resonant system may be between 0.8~5, 1~3, or 1.5~2.5. In some embodiments, the mass m of the mass element 131 and the elastic strength k of the elastic element 132 may be determined first to determine that the resonant frequency of the vibration sensor is within the range described above. For example, the elastic strength of the elastic element is 10 N/m~2000 N/m, and the mass of the mass element is 0.001 g~1 g, then, the damping c of the resonant system may be determined to make the quality factor Q of the resonant system be 0.7~10, so as to further improve the sensitivity of the vibration sensor. In some embodiments, the elastic strength of the elastic element may be between 10 N/m~2000 N/m, and the mass of the mass element may be between 0.02 g~0.03 g. In some embodiments, the elastic strength of the elastic element may be between 10 N/m~800 N/m, and the mass of the mass element may be between 0.01 g~0.05 g. In some embodiments, the elastic strength of the elastic element may be between 30 N/m~2000 N/m, and the mass of the mass element may be between 0.05 g~0.1 g. In some embodiments, the elastic strength k of the elastic element 132 may be 2000 N/m, and the mass m of the mass element 131 may be 0.03 g. Correspondingly, the resonant frequency of the vibration sensor may be about 8000 Hz. In some embodiments, the elastic strength k of the elastic element 132 may be 10 N/m, and the mass m of the mass element 131 may be 0.015 g. Correspondingly, the resonant frequency of the vibration sensor may be about 800 Hz. In some embodiments, the value of the elastic strength k of the elastic element 132 may be 650 N/m, and the value of the mass m of the mass element 131 may be 0.1 g. Correspondingly, the resonant frequency of the vibration sensor may be about 2600 Hz.

In some embodiments, a relationship between the sound pressure change of the second acoustic cavity 142 and the angular frequency may be further transformed into the following expression:

$$Δ p = \frac{{A}_{0}}{\left(\left({V}_{1} + {V}_{2}\right) / S\right)} \frac{1}{\left({ω}^{2} + j ω \frac{c}{m} - \frac{k}{m}\right)} c o s \left(ω t\right)$$

In formula (11), taking FIG. 1 as an example, take a plane of the mass element 131 that faces away from the elastic element 132 (the plane is represented by a dotted line in FIG. 1) as a division plane, and a volume of the second acoustic cavity 142 may be divided into two parts. When a gap between the elastic element 132 and the housing structure 110 meets requirements for reserved space for assembly and is the smallest, a volume of a side facing away from the acoustic transducer 120 may be V₁, a volume of a side facing toward the acoustic transducer 120 may be V₂. At this time, if a sectional area S of the mass element 131 is adjusted, the volume V₁ of the side facing away from the acoustic transducer 120 may not change; the volume V₂ of the side facing toward the acoustic transducer 120 may vary with a size of the cross-sectional area S of the mass element 131. V₂/S may represent a distance between the mass element 131 and the acoustic transducer 120. It may be seen from formula (11) that the volume of the second acoustic cavity 142 may be reduced by increasing the cross-sectional area S of the mass element 131 or reducing assembly gaps in the second acoustic cavity 142, thereby improving the sensitivity of the vibration sensor. The assembly gap may be a space that needs to be reserved between each element to prevent the element from being assembled due to process errors or unnecessary contact during assembly. In some embodiments, the assembly gap may refer to a gap in other parts except for V₂ in the second acoustic cavity. For example, the assembly gap may include a gap between the elastic element 132 and the mass element 131, a gap between the elastic element 132 and the housing structure 110, and a gap between the elastic element 132 and the acoustic transducer 120. In some embodiments, a gap spacing between the elastic element 132 and the mass element 131, a gap spacing between the elastic element 132 and the housing structure 110, and a gap spacing between the elastic element 132 and the acoustic transducer 120 may not be greater than 0.1 mm.

Because the acoustic transducer may generate electrical signal noise, using an acoustic transducer with a high signal-to-noise ratio may help improve the signal-to-noise ratio of the vibration sensor. In some embodiments, the signal-to-noise ratio of the selected acoustic transducer may be greater than 63 dB. According to preference for example, the signal-to-noise ratio of the selected acoustic transducer may be greater than 65 dB or 70 dB.

FIG. 5 is a schematic structural diagram of a vibration sensor according to some embodiments of the present disclosure. As shown in FIG. 5, in some embodiments, the vibration sensor may include a housing structure 510, an elastic element 532, a mass element 531, and an acoustic transducer 520. The vibration sensor shown in FIG. 5 may be the same as or similar to the vibration sensor 100. The housing structure 510 may be the same as or similar to the housing structure 110. The elastic element 532 may be the same as or similar to the elastic element 132. The mass element 531 may be the same as or similar to the mass element 131. The elastic element 532 and the mass element 531 may jointly form a vibration unit that may be the same or similar to the vibration unit 130 of the vibration sensor 100. The acoustic transducer 520 may be the same as or similar to the acoustic transducer 120. The second acoustic cavity 542 of the vibration sensor shown in FIG. 5 may be the same or similar to the second acoustic cavity 142 of the vibration sensor 100.

The acoustic transducer 520, the housing structure 510, the elastic element 532 and the mass element 531 may form a second acoustic cavity 542. The elastic element 532 may be located on a side of the mass element 531 that may be away from the acoustic transducer 520. One end of the elastic element 532 may be connected with the housing structure 510, and another end of the elastic element 532 may be connected with the mass element 531. As an example only, the elastic element 532 may be a structure of a hollow cylinder, which may be distributed around a central axis of the mass element 531 (that is, an axis passing through the center of the mass element 531). As shown in FIG. 5, assuming that a top end of the housing structure 510 is an end that contacts the face and receives the vibration signal, a bottom end of the elastic element 532 may be fixedly connected to a side facing the top end of the housing structure 510 of the mass element 531, and a top end of the elastic element 532 may be fixedly connected to a side facing the mass element 531 of the housing structure 510. In some alternative embodiments, a position where the elastic element 532 is connected to the housing structure 510 may be located on a side wall of the housing structure 510.

In some embodiments, materials of the elastic element 532 may include metallic materials or non-metallic materials. The metallic materials may include, but may be not limited to, steel (e.g., stainless steel, carbon steel, etc.), light alloys (e.g., aluminum alloy, beryllium copper, magnesium alloy, titanium alloy, etc.), or any combination thereof. The non-metallic materials may include but be not limited to polyurethane foam materials, glass fibers, carbon fibers, boron fibers, graphite fibers, graphene fibers, silicon carbide fibers, aramid fibers, etc. In some embodiments, types of the materials of the elastic element 532 may also be classified in other ways, not limited to the above-mentioned metal materials and non-metallic materials. For example, the types of materials of the elastic element 532 may also include single materials or composite materials. In some embodiments, the materials used by the mass element 5321 may include the above described metallic materials or non-metallic materials, which will not be described here.

In some embodiments, the elastic element 532, the mass element 531 and the housing structure 510 may be bonded with adhesives, or other connection manners (such as welding, clamping, etc.) familiar to those skilled in the art used, without limitation.

FIG. 6 is a schematic structural diagram of a vibration sensor according to some embodiments of the present disclosure. The vibration sensor shown in FIG. 6 may be roughly the same as the vibration sensor shown in FIG. 5. A difference of the vibration sensor shown in FIG. 6 from the vibration sensor shown in FIG. 5 may be that in the vibration sensor shown in FIG. 6, the elastic element 632 may be located at a peripheral side of the mass element 631, an inner side of the elastic element 632 may be connected with the mass element 631, and an end of the elastic element 632 away from the acoustic transducer 620 may be still connected with the housing structure 610. A height of the elastic element 632 in the axial direction of the mass element 631 may be less than, equal to or greater than a height of the mass element 631 in the axial direction. The acoustic transducer 620, the housing structure 610, the elastic element 632 and the mass element 631 may form the second acoustic cavity 642.

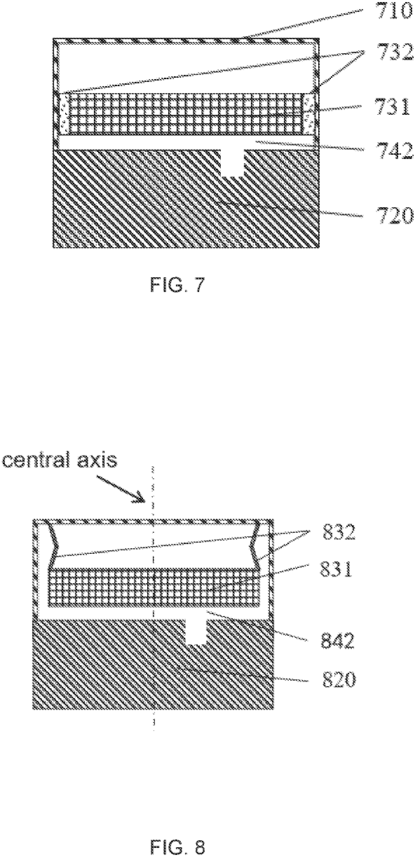

FIG. 7 is a schematic structural diagram of a vibration sensor according to some embodiments of the present disclosure. The vibration sensor shown in FIG. 7 may be roughly the same as the vibration sensor shown in FIG. 5. A difference of the vibration sensor shown in FIG. 7 from the vibration sensor shown in FIG. 5 may be that the elastic element 732 is located on a peripheral side of the mass element 731, wherein an outer side of the elastic element 732 may be connected with a side wall of the housing structure 710, and an inner side of the elastic element 732 may be connected with the mass element 731. A height of the elastic element 732 in an axial direction of the mass element 731 may be less than, equal to or greater than the height of the mass element 731 in the axial direction. The acoustic transducer 720, the housing structure 710, the elastic element 732 and the mass element 731 may form a second acoustic cavity 742.

FIG. 8 is a schematic structural diagram of a vibration sensor according to some embodiments of the present disclosure. The vibration sensor shown in FIG. 8 may be roughly the same as the vibration sensor shown in FIG. 5. A difference of the vibration sensor shown in FIG. 8 from the vibration sensor shown in FIG. 5 may be that a structure of the elastic element 832 shown in FIG. 8 may be different from a structure of the elastic element 532 shown in FIG. 5. A section shape of the elastic element 832 on a section where the axis is located may be circular arc or wave shape symmetrical on both sides. It may be considered that the vibration direction of the mass element 831 relative to the housing structure 810 may be the axial direction. In some embodiments, a section where the axis is located may be a section collinear or parallel to the axis of the vibration sensor. In some embodiments, the section shape of the elastic element 832 may be an inward concave arc or wave shape. In some embodiments, the section shape of the elastic element 832 may also be an outward convex arc or wave shape. In some embodiments, the section shape of the elastic element may also be rectangular, trapezoidal, parallelogram or any other regular or irregular shape. On the one hand, since an elastic coefficient of the elastic element 832 is related to a shape of the elastic element 832, the elastic coefficient of the elastic element 832 may be adjusted by changing a shape of the elastic element 832, and then the resonant frequency of the vibration sensor may be adjusted to further improve the sensitivity of the vibration sensor. On the other hand, the shape of the elastic element 832 may affect a volume of the second acoustic cavity 842 during deformation, thereby improving the sensitivity of the vibration sensor. For example, when the section shape of the elastic element 832 is concave arc, the deformation of the elastic element 832 may mainly be caused by the deformation of the shape of the elastic element 832. When the mass element 831 moves downward, the concave part of the elastic element 832 may expand outward with the deformation, which may further reduce the volume of the second acoustic cavity 842, thereby improving the sensitivity of the vibration sensor.

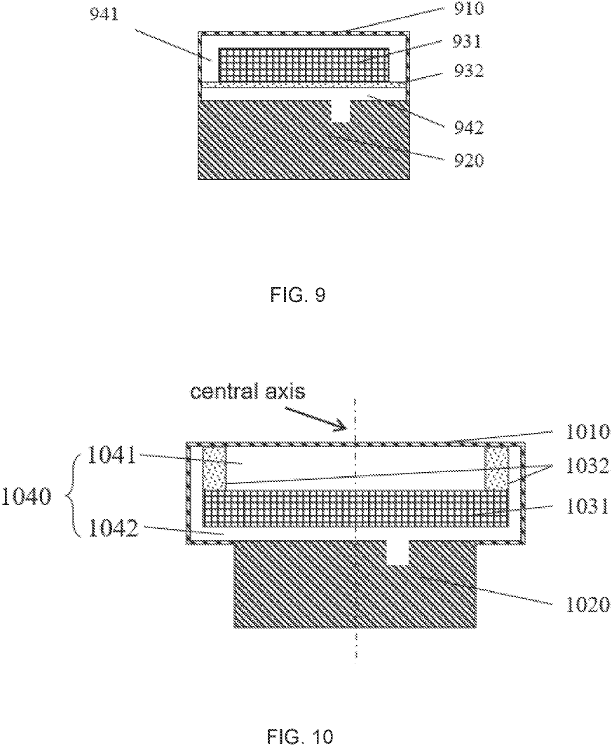

FIG. 9 is a schematic structural diagram of a vibration sensor according to some embodiments of the present disclosure. The vibration sensor shown in FIG. 9 may be the same as or similar to the vibration sensor 100. The housing structure 910 may be the same as or similar to the housing structure 110. The mass element 931 may be the same as or similar to the mass element 131. The elastic element 932 and the mass element 931 may jointly form a vibration unit that is the same or similar to the vibration unit 130 of the vibration sensor 100. The acoustic transducer 920 may be the same as or similar to the acoustic transducer 120. The second acoustic cavity 942 of the vibration sensor shown in FIG. 9 may be the same or similar to the second acoustic cavity 142 of the vibration sensor 100. The third acoustic cavity 941 of the vibration sensor shown in FIG. 9 may be the same or similar to the second acoustic cavity 141 of the vibration sensor 100. In some embodiments, the elastic element 932 may be a planar structure. The elastic element 932 may be located on a side of the mass element 931 toward the acoustic transducer 920, wherein the elastic element 932 may be connected with the housing structure 910. In some embodiments, a peripheral side of the elastic element 932 may be sealed with a side wall of the housing structure 910. The sealing connection here may refer to that the elastic element 932 isolates the third acoustic cavity 941 and the second acoustic cavity 942. In some embodiments, a side of the mass element 931 opposite to the acoustic transducer 920 may be partially or completely bonded to the elastic element 932. For example, one side of the mass element 931 opposite to the acoustic transducer 920 may be fully bonded to the elastic element 932. As another example, the elastic element 932 may be provided with a through part whose area is less than or equal to an area of the side part of the acoustic transducer 920, and the mass element 931 may cover the through part or fit with a through part. The elastic element 932, the housing structure 910 and the acoustic transducer 920 may form a second acoustic cavity 942. It should be noted that the planar structure of the elastic element 932 may be not limited to a flat plate structure. For example, the surfaces on both sides of the elastic element 932 may be concave, convex, and other non-planar. The shape and structure of the elastic element 932 may be adjusted according to a specific situation.

FIG. 10 is a schematic structural diagram of a vibration sensor according to some embodiments of the present disclosure. The vibration sensor shown in FIG. 10 may be roughly the same as that shown in FIG. 5, with a difference that the cross-sectional area of the mass element 1031 may be larger than the cross-sectional area of the acoustic transducer 1020. It may be known from the above formula (10) that when the cross-sectional area of the acoustic transducer 1020 is fixed, the sensitivity of the vibration sensor can be improved by increasing the cross-sectional area of the mass element 1031. As an example, the mass element 1031 may have a cross-sectional area of about 5 mm², and the acoustic transducer 1020 may have a cross-sectional area of about 4 mm². It should be noted that the cross-sectional areas of the mass element 1031 and the acoustic transducer 1020 may be adaptively adjusted according to the scenario of the vibration sensor of the present disclosure. For example, when a size of the vibration sensor is large, the cross-sectional areas of the mass element 1031 and the acoustic transducer 1020 may be enlarged at the same time, or the cross-sectional area of the mass element 1031 may be increased, or the cross-sectional area of the acoustic transducer 1020 may be reduced. As another example, when the size of the vibration sensor is small, the cross-sectional area of the mass element 1031 and the acoustic transducer 1020 may be reduced at the same time, or the cross-sectional area of the acoustic transducer 1020 may be reduced. In addition, the section area here may refer to a section area perpendicular to the axial direction. It should be noted that the elastic element 1032 and the mass element 1031 of the vibration sensor in FIG. 10 may have the same or similar structure as the elastic element 632 and the mass element 631 in FIG. 6. That is, the elastic element 1032 may be located on the peripheral side of the mass element 1031, and an inner side of the elastic element 1032 may be connected with the mass element 1031. Alternatively, the elastic element 1032 and the mass element 1031 may have the same or similar structure as the elastic element 732 and the mass element 731 in FIG. 7. That is, the elastic element 1032 may be located on the peripheral side of the mass element 1031, wherein the outer side of the elastic element 1032 may be connected with a side wall of the housing structure 1010, and the inner side of the elastic element 1032 may be connected with the mass element 1031. Alternatively, the elastic element 1032 may have the same or similar structure as the elastic element 832 in FIG. 8. Alternatively, the elastic element 1032 and the mass element 1031 may have the same or similar structure as the elastic element 932 and the mass element 931 in FIG. 9. Alternatively, the elastic element 1032 and the mass element 1031 may also have other similar shape and position changes, for example, the elastic element 832 in FIG. 8 may be connected to the peripheral side of the mass element in a way similar to the elastic element 632 in FIG. 6. This embodiment may be not limited.

In some embodiments, the sensitivity of the vibration sensor can also be improved by adjusting the assembly gaps at various parts of the elements in the first acoustic cavity 1040 (for example, the second acoustic cavity 1042 and the third acoustic cavity 1041). In some embodiments, the gap spacing between the elastic element 1032 and the mass element 1031, the gap spacing between the elastic element 1032 and the housing structure 1010, and the gap spacing between the elastic element 1032 and the acoustic transducer 1020 may be less than or equal to 0.1 mm.

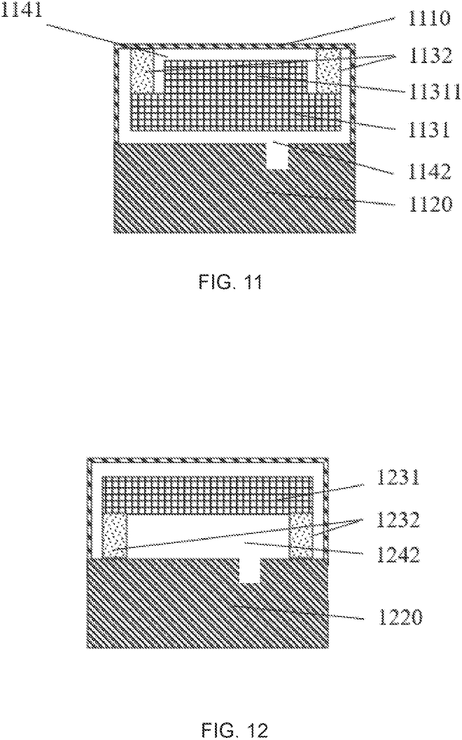

FIG. 11 is a schematic structural diagram of a vibration sensor according to some embodiments of the present disclosure. The vibration sensor shown in FIG. 11 may be roughly the same as the vibration sensor shown in FIG. 5. A difference between the vibration sensor shown in FIG. 11 and the vibration sensor shown in FIG. 5 may be that the mass element 1131 has a first protrusion 11311, which may be located in the third acoustic cavity 1141 defined by the housing structure 1110, the elastic element 1132 and the mass element 1131 on a side where the mass element 1131 is away from the acoustic transducer 1120. In some embodiments, setting a first protrusion 11311 at a side of the mass element 1131 away from the acoustic transducer may increase the mass of the mass element 1131, adjust the resonant frequency of the vibration sensor, and thus improve the sensitivity of the vibration sensor. Meanwhile, since the first protrusion 11311 is located in the third acoustic cavity 1141, the overall volume of the vibration sensor may not be increased on a premise of improving the sensitivity of the vibration sensor. It should be noted that the elastic element 1132 and the mass element 1131 of the vibration sensor in FIG. 11 may have the same or similar structure as the elastic element 632 and the mass element 631 in FIG. 6. That is, the elastic element 1132 may be located on a peripheral side of the mass element 1131, and an inner side of the elastic element 1132 may be connected with the mass element 1131. Alternatively, the elastic element 1132 and the mass element 1131 may have the same or similar structure as the elastic element 732 and the mass element 731 in FIG. 7. That is, the elastic element 1132 may be located on the peripheral side of the mass element 1131, wherein an outer side of the elastic element 1132 may be connected with a side wall of the housing structure 1110, and the inner side of the elastic element 1132 may be connected with the mass element 1131. Alternatively, the elastic element 1132 may have the same or similar structure as the elastic element 832 in FIG. 8. Alternatively, the elastic element 1132 and the mass element 1131 may have the same or similar structure as the elastic element 932 and the mass element 931 in FIG. 9. Alternatively, the elastic element 1132 and the mass element 1131 may also have other similar changes in shape and position. For example, the elastic element 832 in FIG. 8 may be connected to the peripheral side of the mass element in a way similar to the elastic element 632 in FIG. 6. This embodiment may be not limited.

FIG. 12 is a schematic structural diagram of a vibration sensor according to some embodiments of the present disclosure. The vibration sensor shown in FIG. 12 may be roughly the same as the vibration sensor shown in FIG. 5, with a difference that the elastic element 1232 is located on a side of the mass element 1231 towards the acoustic transducer 1220. One end of the elastic element 1232 may be connected with the mass element 1231, and the other end of the elastic element 1232 may be connected with the acoustic transducer 1220. The elastic element 1232 and the acoustic transducer 1220 may form the second acoustic cavity 1242. A structure and connection mode in this embodiment may further reduce a volume of the second acoustic cavity 1242, thereby improving the sensitivity of the vibration sensor. It should be noted that the elastic element 1232 and the mass element 1231 of the vibration sensor in FIG. 12 may have the same or similar structure as the elastic element 632 and the mass element 631 in FIG. 6, that is, the elastic element 1232 may be located on a peripheral side of the mass element 1231, and an inner side of the elastic element 1232 may be connected with the mass element 1231. Alternatively, the elastic element 1232 may have the same or similar structure as the elastic element 832 in FIG. 8. Alternatively, the elastic element 1232 and the mass element 1231 may also have other similar changes in shape and position. For example, the elastic element 832 in FIG. 8 may be connected to the peripheral side of the mass element in a way similar to the elastic element 632 in FIG. 6. This embodiment may be not limited.

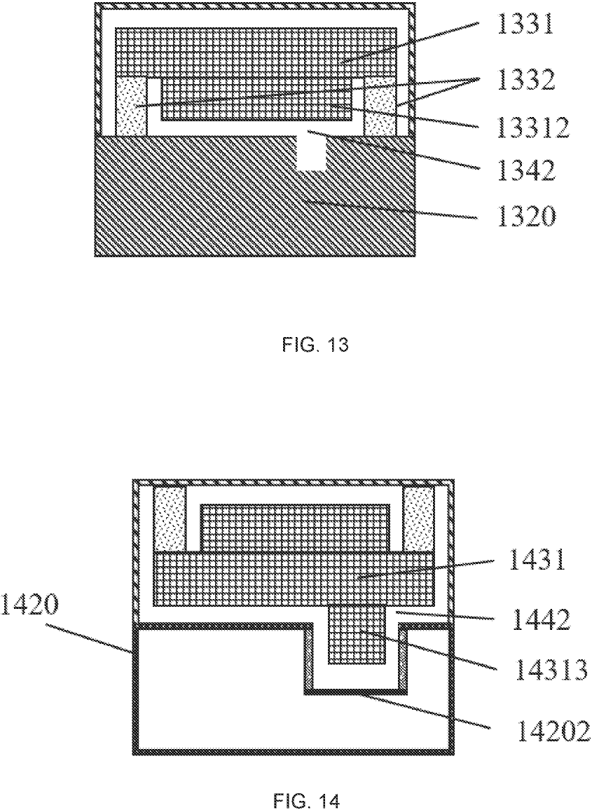

FIG. 13 is a schematic structural diagram of a vibration sensor according to some embodiments of the present disclosure. The vibration sensor shown in FIG. 13 may be roughly the same as the vibration sensor shown in FIG. 12. A difference between the vibration sensor shown in FIG. 13 and the vibration sensor shown in FIG. 12 may be that the mass element 1331 has a second protrusion 13312, which may be located in the second acoustic cavity 1320 defined by the elastic element 1332 and the mass element 1131 on a side of the mass element 1331 toward the acoustic transducer 1320. In some embodiments, setting the second protrusion 13312 on the side of the mass element 1331 toward the acoustic transducer 1320 may increase the mass of the mass element 1331, while further reducing the volume of the second acoustic cavity 1342 to adjust the resonant frequency of the vibration sensor, thereby improving the sensitivity of the vibration sensor, without increasing the overall volume of the vibration sensor.

FIG. 14 is a schematic structural diagram of a vibration sensor according to some embodiments of the present disclosure. The vibration sensor shown in FIG. 14 may be roughly the same as the vibration sensor shown in FIG. 11. A difference between the vibration sensor shown in FIG. 14 and the vibration sensor shown in FIG. 11 may be that the mass element 1431 also has a third protrusion 14313, wherein the third protrusion 14313 may be located on a side of the mass element 1431 toward the acoustic transducer 1420, and the third protrusion 14313 may at least partially extend into the acoustic transducer 1420. In some embodiments, the acoustic transducer 1420 may be provided with a groove opposite to the third protrusion 14313, through which the third acoustic protrusion 14313 may extend into the acoustic transducer 1420. In some embodiments, the acoustic transducer 1420 may include an acoustic diaphragm 14202, which may be located in the groove. By setting the third protrusion 14313, a volume of the mass element 1431 can be further increased without increasing the overall volume of the vibration sensor, thereby increasing the mass of the mass element 1431, so as to adjust the resonant frequency of the vibration sensor, reduce the volume of the second acoustic cavity 1442, and thus improve the sensitivity of the vibration sensor.

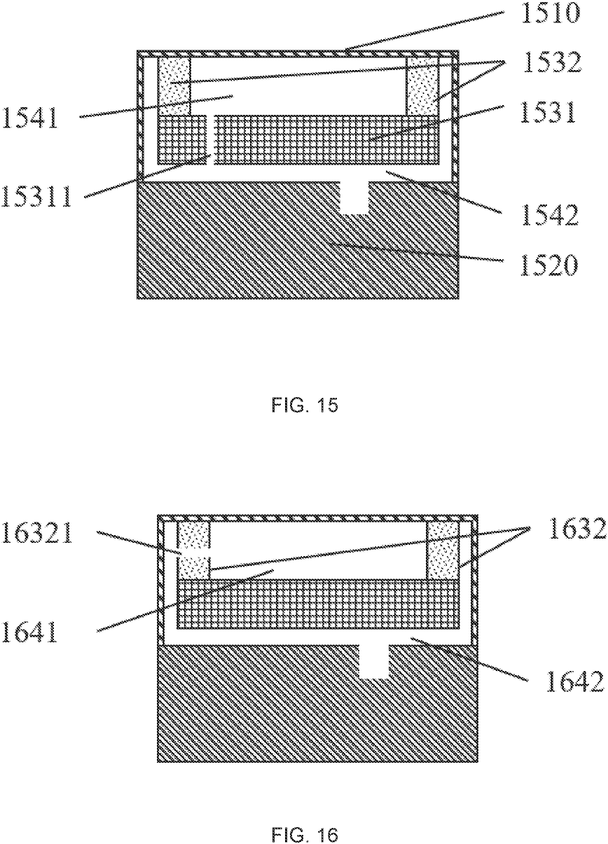

FIG. 15 is a schematic structural diagram of a vibration sensor according to some embodiments of the present disclosure. The vibration sensor shown in FIG. 15 may be the same as or similar to the vibration sensor 100. The housing structure 1510 may be the same as or similar to the housing structure 110. The elastic element 1532 may be the same as or similar to the elastic element 132. The mass element 1531 may be the same as or similar to the mass element 131. The elastic element 1532 and the mass element 1531 may jointly form a vibration unit that may be the same or similar to the vibration unit 130 of the vibration sensor 100. The acoustic transducer 1520 may be the same as or similar to the acoustic transducer 120. The second acoustic cavity 1542 of the vibration sensor shown in FIG. 15 may be the same as or similar to the second acoustic cavity 142 of the vibration sensor 100. The third acoustic cavity 1541 of the vibration sensor shown in FIG. 15 may be the same as or similar to the second acoustic cavity 141 of the vibration sensor 100. As shown in FIG. 15, the mass element 1531 may be provided with at least one first pressure relief hole 15311, and the first pressure relief hole 15311 may penetrate the mass element 1531. The first pressure relief hole 15311 may connect the second acoustic cavity 1542 with the third acoustic cavity 1541, which may help to balance an air pressure difference between the second acoustic cavity 1542 and the third acoustic cavity 1541, which may be generally caused by assembly. For example, in an assembly process of an acoustic output device, environmental conditions and assembly manners when the third acoustic cavity 1541 is formed and the second acoustic cavity 1542 is formed may be different, so that the air pressure in the third acoustic cavity 1541 and the second acoustic cavity 1542 may be different, with an air pressure difference. In some embodiments, the elastic element 1532 may be installed on the housing structure 1510, the mass element 1531 may be installed on the elastic element 1532 to form the third acoustic cavity 1541, and the housing structure 1510 may be installed on the acoustic transducer 1520 to form the second acoustic cavity 1542. The first pressure relief hole 15311 may allow gas in the third acoustic cavity 1541 and the second acoustic cavity 1542 to flow, thereby balancing the air pressure difference. The first pressure relief hole 15311 may have a first acoustic impedance. By adjusting the first acoustic impedance, a predetermined low-frequency roll off response of the vibration sensor may be set, that is, a vibration sensor response lower than the predetermined frequency may be reduced. In some cases, it may help to eliminate a noise signal lower than the predetermined frequency, and/or avoid overloading of the equipment. A shape of a low-frequency roll off response curve may be related to a size of the first pressure relief hole, for example, the larger first pressure relief hole 15311 may have a smaller first acoustic impedance, which may lead to a larger low-frequency attenuation. It should be noted that the first pressure relief hole 15311 should not affect the acoustic sealing of the second acoustic chamber 1542 and the third acoustic chamber 1541.

FIG. 16 is a schematic structural diagram of a vibration sensor according to some embodiments of the present disclosure. The vibration sensor shown in FIG. 16 may be roughly the same as the vibration sensor shown in FIG. 15. A difference between the vibration sensor shown in FIG. 16 and the vibration sensor shown in FIG. 15 may be that the elastic element 1632 is provided with at least one second pressure relief hole 16321, and the second pressure relief hole 16321 penetrates through the elastic element 1632. The second pressure relief hole 16321 may play the same role as the first pressure relief hole 15311. Similarly, the second pressure relief hole 16321 shall not affect the acoustic sealing of the second acoustic cavity 1642 and the third acoustic cavity 1641. In some embodiments, the vibration sensor may have both a first pressure relief hole on the mass element and a second pressure relief hole on the elastic element.

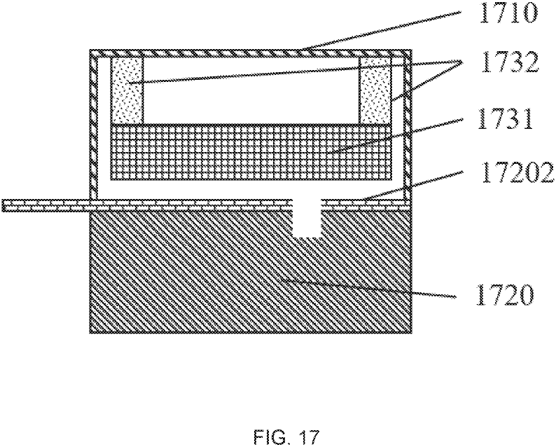

FIG. 17 is a schematic structural diagram of a vibration sensor according to some embodiments of the present disclosure. The vibration sensor shown in FIG. 17 may be roughly the same as the vibration sensor shown in FIG. 5. A difference between the vibration sensor shown in FIG. 17 and the vibration sensor shown in FIG. 5 may be that the vibration sensor includes a circuit board 17202, which may be configured to receive and transmit electrical signals from the acoustic transducer 1720. The circuit board 17202 may be located on a side opposite to a position of the acoustic transducer 1720 and the mass element 1731. PCB board or FPC board may be configured for the circuit board 17202, which may be not limited. In some embodiments, the acoustic transducer 1720 may be assembled on the circuit board 17202, and then the housing structure 1710, the elastic element 1732, and the mass element 1731 may be assembled. The housing structure 1710, the elastic element 1732, and the mass element 1731 may be preassembled integral components, which in some cases may help to improve a flexibility of the assembly. It should be noted that the elastic element 1732 and the mass element 1731 of the vibration sensor in FIG. 17 may have the same or similar structure as the elastic element 632 and the mass element 631 in FIG. 6. That is, the elastic element 1732 may be located on a peripheral side of the mass element 1731, and the inner side of the elastic element 1732 may be connected with the mass element 1131. Alternatively, the elastic element 1732 and the mass element 1731 may have the same or similar structure as the elastic element 732 and the mass element 731 in FIG. 7. That is, the elastic element 1732 may be located on the peripheral side of the mass element 17131, wherein an outer side of the elastic element 1732 may be connected with a side wall of the housing structure 1710, and the inner side of the elastic element 1732 may be connected with the mass element 1731. Alternatively, the elastic element 1732 may have the same or similar structure as the elastic element 832 in FIG. 8. Alternatively, the elastic element 1732 and the mass element 1731 may have the same or similar structure as the elastic element 932 and the mass element 931 in FIG. 9. Alternatively, the elastic element 1732 and the mass element 1731 may also have other similar changes in shape and position. For example, the elastic element 832 in FIG. 8 may be connected to the peripheral side of the mass element in a way similar to the elastic element 632 in FIG. 6. This embodiment may be not limited.

Those skilled in the art may combine solutions of the embodiments shown in FIGS. 5 to 17 in a reasonable manner, and such combination still belongs to the spirit and scope of the exemplary embodiments of the present disclosure. For example, by combining schemes of the embodiments shown in FIGS. 8, 11 and 15, the elastic element may have the same or similar structure as the elastic element 832 in FIG. 8, that is, a section shape of the elastic element on the section where the axis is located may be an arc or wave shape symmetrical on both sides, and the mass element may have the same or similar structure as the mass element 1131 in FIG. 11, that is, the mass element may have a first protrusion. The first protrusion may be on a side where the mass element is away from the acoustic transducer. At the same time, the mass element may have the same or similar structure as the mass element 1531 in FIG. 15, that is, the mass element may be provided with at least one first pressure relief hole.

The basic concepts have been described above. Obviously, for those skilled in the art, the above detailed disclosure is only an example and does not constitute a limitation of the present disclosure. Although it is not explicitly stated here, those skilled in the art may make various modifications, improvements, and amendments to the present disclosure. Such modifications, improvements and amendments are suggested in the present disclosure, so such modifications, improvements and amendments still belong to the spirit and scope of the exemplary embodiments of the present disclosure.

Meanwhile, the present disclosure uses specific words to describe the embodiments of the present disclosure. For example, “one embodiment”, and/or “some embodiments” mean a certain feature or structure related to at least one embodiment of the present disclosure. Therefore, it should be emphasized and noted that “one embodiment” or “an alternative embodiment” mentioned twice or more in different positions in the present disclosure does not necessarily refer to the same embodiment. In addition, certain features or structures in one or more embodiments of the present disclosure may be appropriately combined.

In addition, unless explicitly stated in the claims, the sequence of processing elements and sequences, the use of numbers and letters, or the use of other names described in the present disclosure are not used to define the sequence of processes and methods in the present disclosure. Although the above disclosure has discussed some currently considered useful embodiments of the invention through various examples, it should be understood that such details are only for the purpose of explanation, and the additional claims are not limited to the disclosed embodiments. On the contrary, the claims are intended to cover all amendments and equivalent combinations that conform to the essence and scope of the embodiments of the present disclosure. For example, although the system components described above can be implemented by hardware devices, they can also be implemented only by software solutions, such as installing the described system on an existing server or mobile device.

A computer storage medium may contain a propagated data signal embodying a computer program code, for example, in baseband or as part of a carrier wave. The propagated signal may have various manifestations, including electromagnetic form, optical form, etc., or a suitable combination. A computer storage medium may be any computer-readable medium, other than a computer-readable storage medium, that can be used to communicate, propagate, or transfer a program for use by being coupled to an instruction execution system, apparatus, or device. Program code residing on a computer storage medium may be transmitted over any suitable medium, including radio, electrical cable, fiber optic cable, RF, or the like, or combinations of any of the foregoing.

The computer program codes required for the operation of each part of the present disclosure may be written in any one or more programming languages, including object-oriented programming languages such as Java, Scala, Smalltalk, Eiffel, JADE, Emerald, C++, C#, VB.NET, Python etc., conventional procedural programming languages such as C language, Visual Basic, Fortran 2003, Perl, COBOL 2002, PHP, ABAP, dynamic programming languages such as Python, Ruby and Groovy, or other programming languages, etc. The program code may run entirely on the user’s computer, or as a stand-alone software package, or run partly on the user’s computer and partly on a remote computer, or entirely on the remote computer or server. In the latter case, the remote computer may be connected to the user computer through any form of network, such as a local area network (LAN) or wide area network (WAN), or to an external computer (such as through the Internet), or in a cloud computing environment, or as a service Use software as a service (SaaS).

In addition, unless explicitly stated in the claims, the sequence of processing elements and sequences, the use of numbers and letters, or the use of other names described in the present disclosure are not used to define the sequence of processes and methods in the present disclosure. Although the above disclosure has discussed some currently considered useful embodiments of the invention through various examples, it should be understood that such details are only for the purpose of explanation, and the additional claims are not limited to the disclosed embodiments. On the contrary, the claims are intended to cover all amendments and equivalent combinations that conform to the essence and scope of the embodiments of the present disclosure. For example, although the system components described above can be implemented by hardware devices, they can also be implemented only by software solutions, such as installing the described system on an existing server or mobile device.

Similarly, it should be noted that, in order to simplify the description disclosed in the present disclosure and thus help the understanding of one or more embodiments of the invention, the foregoing description of the embodiments of the present disclosure sometimes incorporates a variety of features into one embodiment, the drawings or the description thereof. However, this disclosure method does not mean that the object of the present disclosure requires more features than those mentioned in the claims. In fact, the features of the embodiments are less than all the features of the single embodiments disclosed above.

In some embodiments, numbers describing the count of components and attributes are used. It should be understood that such numbers used in the description of embodiments are modified by the modifier “about,” “approximate,” or “generally” in some examples. Unless otherwise stated, “approximately” or “generally” indicate that a ±20% change in the figure is allowed. Accordingly, in some embodiments, the numerical parameters used in the description and claims are approximate values, and the approximate values can be changed according to the characteristics required by individual embodiments. In some embodiments, the numerical parameter should consider the specified significant digits and adopt the method of general digit reservation. Although the numerical fields and parameters used to confirm the range breadth in some embodiments of the present disclosure are approximate values, in specific embodiments, the setting of such values is as accurate as possible within the feasible range.

For each patent, patent application, patent application disclosure and other materials cited in the present disclosure, such as articles, books, specifications, publications, documents, etc., the entire contents are hereby incorporated into the present disclosure for reference. Except for the application history documents that are inconsistent with or conflict with the contents of the present disclosure, and the documents that limit the widest range of claims in the present disclosure (currently or later appended to the present disclosure). It should be noted that in case of any inconsistency or conflict between the description, definitions, and/or use of terms in the supplementary materials of the present disclosure and the contents described in the present disclosure, the description, definitions, and/or use of terms in the present disclosure shall prevail.

Finally, it should be understood that the embodiments described in the present disclosure are only used to illustrate the principles of the embodiments of the present disclosure. Other deformations may also fall within the scope of the present disclosure. Therefore, as an example rather than a limitation, the alternative configuration of the embodiments of the present disclosure can be regarded as consistent with the teachings of the present disclosure. Accordingly, the embodiments of the present disclosure are not limited to those explicitly introduced and described in the present disclosure.

1. A vibration sensor, comprising:
a housing structure and an acoustic transducer, wherein the acoustic transducer is physically connected to the housing structure, a first acoustic cavity is formed at least partially by the housing structure and the acoustic transducer; and
a vibration unit, wherein the vibration unit is located in the first acoustic cavity, and separates the first acoustic cavity into a second acoustic cavity and a third acoustic cavity, the second acoustic cavity is in acoustic communication with the acoustic transducer;
wherein the housing structure is configured to vibrate based on an external vibration signal, the vibration unit changes a volume of the second acoustic cavity in response to the vibration of the housing structure, and the acoustic transducer generates an electrical signal based on the volume change of the second acoustic cavity; and
the vibration unit acts on the second acoustic cavity so that a resonance frequency of the vibration sensor is 800 Hz-8000 Hz.

2. The vibration sensor of claim 1, wherein
the vibration unit, the housing structure, and the acoustic transducer form a resonant system, and a quality factor of the resonant system is 0.7-10.

3. The vibration sensor of claim 1, wherein
the vibration unit includes a mass element and an elastic element, and the mass element is connected to the housing structure or the acoustic transducer through the elastic element.

4. The vibration sensor of claim 3, wherein
an elastic strength of the elastic element is 10 N/m-2000 N/m.

5. The vibration sensor of claim 3, wherein
a mass of the mass element is 0.001 g-1 g.

6. The vibration sensor of claim 3, wherein the elastic element is located on a side of the mass element away from the acoustic transducer, one end of the elastic element is connected to the housing structure, the other end of the elastic element is connected to the mass element.

7. The vibration sensor of claim 6, wherein a first protrusion is disposed on the side of the mass element away from the acoustic transducer.

8. The vibration sensor of claim 6, wherein the vibration sensor further comprises a circuit board configured to receive and deliver the electrical signal output by the acoustic transducer; wherein the circuit board is located on a side of the acoustic transducer opposite to the mass element.

9. The vibration sensor of claim 3, wherein the elastic element is located on a side of the mass element facing the acoustic transducer, one end of the elastic element is connected to the mass element, and the other end of the elastic element is connected to the acoustic transducer.

10. The vibration sensor of claim 9, wherein the side of the mass element facing the acoustic transducer is provided with a second protrusion.

11. The vibration sensor claim 6, wherein the side of the mass element facing the acoustic transducer is provided with a third protrusion, and the third protrusion at least partially protrudes into the acoustic transducer, and is opposite to a position of a diaphragm of the acoustic transducer.

12. The vibration sensor of claim 3, wherein the elastic element is a planar structure, the elastic element is located on the side of the mass element facing the acoustic transducer, the elastic element is connected to the housing structure, and a side surface of the mass element facing the acoustic transducer is connected with the elastic element.

13. The vibration sensor of claim 3, wherein the elastic element is located on a peripheral side of the mass element, an outer side of the elastic element is connected to the housing structure, and an inner side of the elastic element is connected to the mass element.

14. The vibration sensor of claim 3, wherein the elastic element is located on a peripheral side of the mass element, an inner side of the elastic element is connected to the mass element, and an end of the elastic element is connected to the housing structure or the acoustic transducer.

15. The vibration sensor of claim 3, wherein a cross-sectional shape of the elastic element is a rectangle, a trapezoid, a parallelogram, an arc, or a wave.

16. The vibration sensor of claim 3, wherein at least one first pressure relief hole is provided on the mass element, and the at least one first pressure relief hole penetrates through the mass element.

17. The vibration sensor of claim 3, wherein the elastic element is provided with at least one second pressure relief hole, and the at least one second pressure relief hole penetrates through the elastic element.

18. The vibration sensor of claim 3, wherein a cross-sectional area of the mass element is larger than a cross-sectional area of the acoustic transducer.

19. The vibration sensor of claim 3, wherein a gap distance between the elastic element and the housing structure and a gap distance between the elastic element and the acoustic transducer are less than or equal to 0.1 mm.

20. The vibration sensor of claim 1, wherein the vibration unit acts on the second acoustic cavity so that a resonance frequency of the vibration sensor is 1500 Hz-3000 Hz.
